(19) United States
(12) Patent Application Publication
(10) Pub. No.: US 2026/0334489 A1
(43) Pub. Date: Oct. 29, 2026

(54) STERILIZED FERMENTED MILK AND PRODUCTION METHOD FOR SAME

(71) Applicant: MEIJI CO., LTD., Tokyo (JP)

(72) Inventors: Takefumi ICHIMURA, Tokyo (JP); Megumi TADA, Tokyo (JP)

(73) Assignee: MEIJI CO., LTD., Tokyo (JP)

(21) Appl. No.: 19/111,583

(22) PCT Filed: Sep. 13, 2023
(86) PCT No.: PCT/JP2023/033460

§ 371 Date: Mar. 13, 2025

(30) Foreign Application Priority Data
Sep. 14, 2022 (JP) 2022-146607

(51) Int. Cl. A23C 9/123; A23B 11/123

(52) U.S. Cl. CPC A23C 9/123; A23B 11/123

(57) ABSTRACT

The present invention provides set-type pasteurized fermented milk and a production method for the set-type pasteurized fermented milk. The set-type pasteurized fermented milk of the present invention contains whey protein in an amount of 1.5 to 3.0 mass % and casein protein in an amount of 2.0 to 3.0 mass %, wherein the amount of the whey protein per 100 parts by mass of the casein protein is 50 to 125 parts by mass, and the set-type pasteurized fermented milk has a pH of 5.3 to 5.9.

### CROSS-REFERENCE TO RELATED PATENT APPLICATIONS

The present application claims priority based on Japanese Patent Application No. 2022-146607, filed on Sep. 14, 2022, the entire disclosure of which is incorporated herein by reference.

### TECHNICAL FIELD

The present invention relates to set-type pasteurized fermented milk and a production method for the set-type pasteurized fermented milk. More specifically, the present invention relates to set-type pasteurized fermented milk that is packed in a container, then fermented (post-fermented), and made firm within the container, and a production method for the set-type pasteurized fermented milk.

### BACKGROUND ART

Amid growing health consciousness, consumer interest in fermented milk is on the rise. If fermented milk can be used in a wider range of dishes, opportunities to consume it are expected increase even more. However, because of its characteristics such as strong sourness and poor shape retention, in practice, fermented milk is mainly eaten as is, or spread on vegetables, meat, or other food ingredients and eaten in a dip style, or mixed with other ingredients as one of the ingredients during cooking.

To simply improve the shape retention of fermented milk, it can have a high-concentration composition or be solidified by adding a gelling agent or thickening polysaccharide; however, when cooked with heat, fermented milk is broken or hardened more than necessary. When heated to high temperatures, fermented milk also develops a strong sour taste. On the other hand, increasing the pH to suppress sourness drastically reduces shape retention; to compensate for this, it becomes necessary to apply a high-concentration composition or use a gelling agent or thickening polysaccharide, which impairs the flavor and texture. In order to expand the application of fermented milk in a wider range of dishes, it is necessary to improve its taste and physical properties, for example by preventing it from disintegrating when cooked, while also reducing its sourness.

No prior art documents were found disclosing fermented milk that does not disintegrate when boiled while having limited sourness without containing a gelling agent or thickening polysaccharide, and a production method for such fermented milk.

PTL 1 and 2 are prior art documents that disclose a technique in common with the production method of the present invention in terms of performing heat treatment (secondary heat treatment) after post-fermentation. However, PTL 1 is characterized in that after fermentation, a β-glucan-containing material (Aureobasidium culture medium) is added as a stabilizer, and then the mixture is heated. Further, after heat treatment, the mixture is homogenized so as to liquefy. Thus, PIL 1 differs from the present invention in that it is not set-type pasteurized fermented milk. PTL 2 differs from the present invention in that it is characterized by the incorporation of crosslinked modified starch as an ingredient and is directed to soft or drinkable yogurt prepared by breaking curd after fermentation.

### CITATION LIST

### Patent Literature

PTL 1; JP2005-137245A
PTL 2: JP2017-63727A

### SUMMARY OF INVENTION

### Technical Problem

An object of the present invention is to provide set-type pasteurized fermented milk that has a reduced sour taste and that is unlikely to disintegrate even when cooked with heat, and to provide a production method for the set-type pasteurized fermented milk.

### Solution to Problem

The present inventors conducted extensive research to produce set-type fermented milk that has solved the problems above, and found that set-type pasteurized fermented milk having the desired characteristics (low acidity, resistance to disintegration when boiled) can be obtained by adding lactic acid bacteria to a starting-material milk mix containing whey protein in an amount of 1.5 to 3.0 mass % and casein protein in an amount of 2.0 to 3.0 mass % in a specific ratio, fermenting the mix in a container until the pH reaches 5.3 to 5.9, and then subjecting the container to heat treatment so that the heat history is at least 75 °C×15 minutes×normal pressure.

The present invention was completed based on the finding and includes the following embodiments.

### (I) Set-Type Pasteurized Fermented Milk

(I-1) A set-type pasteurized fermented milk, comprising
   whey protein in an amount of 1.5 to 3.0 mass %, and
   casein protein in an amount of 2.0 to 3.0 mass %,
wherein
   the amount of the whey protein per 100 parts by mass of the casein protein is 50 to 125 parts by mass, and
   the set-type pasteurized fermented milk has a pH of 5.3 to 5.9.
(I-2) The pasteurized fermented milk according to (1-1), comprising non-fat milk solids in an amount of 9.5 to 11.2 mass %.
(I-3) The pasteurized fermented milk according to (I-1) or (I-2), having shape retention and/or resistance to disintegration when boiled.
(I-4) The pasteurized fermented milk according to any one of (I-1) to (I-3), having a maximum load at break of 5.0 to 8.0 N in a breaking test using a plunger.

### (II) Method for Producing Set-Type Pasteurized Fermented Milk

(II-1) A method for producing set-type pasteurized fermented milk comprising the steps of:
   (a) adding lactic acid bacteria to a starting-material milk mix to ferment the starting-material milk mix in a container until the pH reaches 5.3 to 5.9, wherein the starting-material milk mix contains whey protein in an amount of 1.5 to 3.0 mass % and casein protein in an amount of 2.0 to 3.0 mass %, and the amount of the whey protein per 100 parts by mass of the casein protein is 50 to 125 parts by mass; and
   (b) heating the obtained fermented milk together with the container so that the heat history is at least the following: 75 °C×15 minutes×normal pressure.
(II-2) The method according to (II-1), wherein the starting-material milk mix contains non-fat milk solids in an amount of 9.5 to 11.2 mass %.
(II-3) The method according to (II-1) or (II-2), wherein the starting-material milk mix is subjected to homogenization and pasteurization before the addition of the lactic acid bacteria.

The production method can also be expressed as follows.

The method according to (II-1) or (II-2), further comprising, before step (a), the step of subjecting the starting-material milk mix to homogenization and pasteurization, the starting-material milk mix containing the whey protein in an amount of 1.5 to 3.0 mass$ and the casein protein in an amount of 2.0 to 3.0 mass %, wherein the amount of the whey protein per 100 parts by mass of the casein protein is 50 to 125 parts by mass.
(II-4) The method according to any one of (II-1) to (II-3), wherein the fermentation temperature is 35 to 48 °C

### Advantageous Effects of Invention

The pasteurized fermented milk of the present invention and the pasteurized fermented milk obtained according to the production method of the present invention have a higher pH of 5.3 to 5.9 as compared to regular fermented milk, which has a pH of about 4.6, and they therefore have a milder sour taste. This makes such pasteurized fermented milk easy to eat and allows it to be combined with many ingredients.

The pasteurized fermented milk of the present invention and the pasteurized fermented milk obtained according to the production method of the present invention also have good shape retention and do not easily disintegrate even when boiled, thus, they are easy to use in a variety of cooking processes, regardless of whether being heated or unheated. Additionally, when the pasteurized fermented milk is boiled, the broth does not easily become cloudy. Thus, the loss of nutrients during cooking is limited, and the appearance of the dish does not deteriorate.

Furthermore, the pasteurized fermented milk of the present invention and the pasteurized fermented milk obtained according to the production method of the present invention can be appropriately adjusted so as to have firmness and/or texture equivalent to those of silken tofu or equivalent to those of firm tofu, and can therefore be used in place of tofu used in commonly eaten tofu dishes (such as yudofu, hot pot dishes, soup ingredients, tofu steak, chilled tofu, and mapo tofu). This will broaden the variety of cooking applications of fermented milk and increase the opportunities for consumers to eat fermented milk, which is a healthy food.

### BRIEF DESCRIPTION OF DRAWINGS

FIG. 1 shows images of the broth (contained in beakers) of Comparative Examples 24 and 25 and Examples 5 and 6 subjected to a broth turbidity test in Experimental Example 2. From the left, Comparative Example 24 (turbidity: >40 NTO), Comparative Example 25 (turbidity: 33.3 NTU), Example 5 (turbidity: 3.9 NTU), and Example 6 (turbidity: >2.9 NTU).

### DESCRIPTION OF EMBODIMENTS

### (I) Set-Type Pasteurized Fermented Milk

Fermented milk is defined in the Ministerial Ordinance Concerning Compositional Standards, etc. for Milk and Milk Products (Ordinance of the Ministry of Health, Labor and Welfare; No. 52 of 1951, revised on Jan. 9, 2015, by the Ministry of Health, Labor and Welfare of Japan) (“Ministerial Ordinance on Milk and Milk Products”below) as being “the products which are obtained by fermenting milk, or milk, etc. containing an equal or greater amount of milk solids-not-fat with lactic acid bacteria or yeast and then forming a paste or liquid, or the frozen product” with the milk solids-not-fat (i.e., non-fat milk solids) set to 8.0% or more. These fermented milk products are broadly classified into the following: (a) firm fermented milk obtained by filling a container with starting-material milk, fermenting it, and solidifying it within the container (which is called “set-type fermented milk” or “post-fermented milk”); (b) gelatinized fermented milk obtained by performing fermentation in a large tank or the like, breaking the curd formed, mixing it with fruit pulp, sauce, etc. as necessary, and packing it in a container (which is called “soft yogurt” or “pre-fermented milk”); and (c) liquid fermented milk obtained by finely crushing the firm fermented milk or gelatinized fermented milk with a homogenizer or the like to liquefy it, mixing it with fruit pulp, sauce, etc. as necessary, and packing it in a container (which is called “drink yogurt”).

The fermented milk targeted by the present invention is, among these fermented milk products, set-type (firm) fermented milk that has been post-fermented using lactic acid bacteria. The fermented milk targeted by the present invention is also prepared by performing pasteurization by heat treatment after fermentation (“pasteurized fermented milk”). Specifically, the fermented milk targeted by the present invention is fermented milk that is produced by performing fermentation and then heating at 75 °C for at least 15 minutes, or performing pasteurization using a method that exerts an equivalent or greater antimicrobial effect.

The pasteurized fermented milk of the present invention contains whey protein in an amount of 1.5 to 3.0 mass % and casein protein in an amount of 2.0 to 3.0 mass % based on the pasteurized fermented milk taken as 100 mass %, wherein the amount of the whey protein per 100 parts by mass of the casein protein (the ratio by mass of solid contents) is 50 to 125 parts by mass.

The content of the whey protein and the content of the casein protein refer to the solids content (solids content equivalent) of each protein contained in pasteurized fermented milk taken as 100 mass % (wet mass).

Whey protein is a mixture of several proteins contained in whey, which is the liquid portion of milk from which casein and fat have been removed. Proteins constituting whey protein include B-lactoglobulin, q-lactalbumin, immunoglobulins, bovine serum albumin, lactoferrin, lactoperoxidase, and proteose peptone, Whey protein is thought to account for about 20 mass % of the milk proteins contained in milk. Casein protein (commonly referred to as “casein”) is a milk protein that accounts for about 80% of milk and is a conjugated protein composed of αₛ₁-casein, αₛ₂-casein, β-casein, and κ-casein.

The content of casein protein and the content of whey protein in pasteurized fermented milk (sample) can be measured according to the following method.

### Casein Protein

90 ml of water is added to 10 g of a sample, and the mixture is heated to about 40 to 42 °C. 1.5 ml of a 10 mass % aqueous acetic acid solution is added thereto and stirred. After the mixture is left to stand for 5 minutes, the precipitate (casein) is collected through filter paper. The precipitate (residue) remaining on the filter paper is washed with water that has been acidified with acetic acid (pH of 4.6), and the residue and the filter paper are together subjected to the combustion method or Kjeldahl method to quantify nitrogen, followed by multiplying the quantified nitrogen by the nitrogen-to-protein conversion factor to determine the casein protein content.

### Whey Protein

The total of all proteins contained in a sample is quantified according to the combustion method or Kjeldahl method, and the casein protein content determined according to the method above is subtracted to determine the whey protein content.

The whey protein content (solids content equivalent) in pasteurized fermented milk taken as 100 mass % (wet mass) is not limited as long as the requirement above is achieved. However, the whey protein content is preferably 1.5 to 3.0 mass %, and more preferably 1.7 to 2.5 mass %. The casein protein content (solids content equivalent) is not limited as long as the requirement above is achieved. However, the casein protein content is preferably 2.3 to 3.0 mass %, and more preferably 2.5 to 3.0 mass %. Furthermore, the amount of the whey protein per 100 parts by mass of the casein protein (the ratio by mass of solids content) is not limited as long as the requirement above is achieved. However, the amount of whey protein per 100 parts by mass of casein protein is preferably 50 to 120 parts by mass, and more preferably 62 to 100 parts by mass.

The content of non-fat milk solids in the pasteurized fermented milk of the present invention is 8 mass % or more based on the standard for fermented milk. The content of non-fat milk solids is preferably 9 to 12 mass %, and more preferably 9.5 to 11.2 mass %.

The pasteurized fermented milk of the present invention may contain, without limitations, milk fat in an amount within the range of 0.5 to 4 mass %, preferably 1 to 3.5 mass %, and more preferably 1.5 to 3.0 mass %; lactose in an amount within the range of 4.4 to 6.7 mass %, preferably 5.0 to 6.2 mass %, and more preferably 5.3 to 5.9 mass %; and saccharides (carbohydrates) other than lactose in an amount within the range of 0 to 10 mass %, preferably 2.5 to 7.5 mass %, and more preferably 4 to 6 mass %.

The type of saccharides other than lactose includes, but is not limited to, monosaccharides (e.g., glucose, fructose, and galactose), disaccharides (e.g., sucrose, maltose, lactose, and trehalose), oligosaccharides (e.g., fructooligosaccharides, soybean oligosaccharides, raffinose (beet oligosaccharides), galactooligosaccharides, and isomaltooligosaccharides), polysaccharides (e.g., EPS (exopolysaccharides) and pectin), and sugar alcohols (e.g., xylitol, sorbitol, and maltitol).

The pasteurized fermented milk of the present invention has a pH of 5.3 to 5.9, which is higher than the pH of regular fermented milk (about 4.6). Thus, the pasteurized fermented milk of the present invention has a less sour taste than regular fermented milk. More preferably, the pasteurized fermented milk of the present invention has a pH of 5.4 to 5.8.

The pasteurized fermented milk of the present invention is firm and has shape retention. Whether pasteurized fermented milk has shape retention can be determined in the manner below: as described in the Experimental Examples below, target pasteurized fermented milk is removed directly from a cylindrical (diameter: 7 cm) cup-shaped container (volume capacity: 100 g) and left to stand on a flat plate, such as a dish at product temperature (25 °C) for 60 minutes. Whether the cup shape does not disintegrate under its own weight and whether the shape is retained are observed. If the shape is retained without breaking, the pasteurized fermented milk can be evaluated as having “shape retention.”

Additionally, the meaning of “the shape is retained without breaking” does not mean only that the cup shape is maintained as it is, but also that the cup shape has slightly sagged with the corners (edges) maintained without flow and breaking.

The pasteurized fermented milk of the present invention has resistance to disintegration when boiled. Whether pasteurized fermented milk has resistance to disintegration when boiled is determined by removing target pasteurized fermented milk directly from a cup-shaped container (volume capacity: 100 g), then immersing it in a 10-fold volume of hot water (80 °C) for 10 minutes (static immersion), and comparing the shape of the pasteurized fermented milk with its shape before immersion (cup shape) to see whether the shape has broken. As described in the Experimental Examples below, pasteurized fermented milk with the shape not broken even after immersion can be evaluated as “having resistance to disintegration when boiled.” The meaning of “the shape not broken” here does not mean only that the cup shape before immersion is retained as it was, but also that the cup shape has generally loosened (swollen) but the corners (edges) are maintained without being broken. More preferably, residual liquid (broth) is obtained by removing pasteurized fermented milk that has underwent the test for resistance to disintegration when boiled described above and is passed through a 60 #filter; then, the filtrate is transparent, and the turbidity measured with a 200P Turbidimeter (HACH) according to the method described in the Experimental Examples below is less than 5 NUT.

Although not limited thereto, the pasteurized fermented milk of the present invention preferably has silken tofu-like firmness (equivalent or similar to silken tofu), firm tofu-like firmness (equivalent or similar to firm tofu), or firmness between that of silken tofu and that of firm tofu. The firmness can be evaluated by eating the pasteurized fermented milk of the present invention, silken tofu, and firm tofu, all adjusted to the same product temperature (e.g., 10 °C), and comparing them. Alternatively, the maximum load (N) measured in a breaking test using a creep meter (e.g., Rheoner II, produced by Yamaden Co., Ltd.) can be compared with that of silken tofu and firm tofu for evaluation. Specifically, as described in the Experimental Examples below, a disk-shaped plunger is lowered from above onto the surface of pasteurized fermented milk (test sample; product temperature: 25 °C) contained in a cup container to apply a load, and the compression curve is measured to determine the maximum value of the load applied until the test sample breaks (maximum load (N) ), When measured under the conditions described in the Experimental Examples below, the pasteurized fermented milk of the present invention preferably has a maximum load within the range of 5.00 to 8.00 N, more preferably 5.10 to 7.00 N, and even more preferably 5.10 to 6.50 N.

Furthermore, although there is no limitation, it is preferred that the tongue sensation felt when the pasteurized fermented milk of the present invention is placed in the mouth and squished with the tongue is a smooth texture like silken tofu (equivalent or similar to silken tofu), a slightly coarse texture like firm tofu (equivalent or similar to firm tofu), or a texture between silken tofu and firm tofu. More preferably, the pasteurized fermented milk has a texture between that of silken tofu and that of firm tofu. As described in the Experimental Examples described below, the texture can be evaluated in the following manner: a panel of experts trained in sensory evaluation compare the texture of the pasteurized fermented milk of the present invention (test sample, product temperature: 10 °C) with the texture of commercially available regular silken tofu and firm tofu having the product temperature adjusted to 10 °C, as controls 1 and 2, and determine whether the smoothness and coarseness felt by the tongue are the same or different.

### (II) Method for Producing Set-Type Pasteurized Fermented Milk

The pasteurized fermented milk of the present invention described above can be produced according to a method including the following steps (a) and (b);
(a) a step of adding lactic acid bacteria to a starting-material milk mix and fermenting the mix in a container until the pH reaches 5.3 to 5.9, the starting material milk mix (100% by wet mass) containing whey protein in an amount of 1.5 to 3.0 mass % calculated as a solid content and casein protein in an amount of 2.0 to 3.0 mass % calculated as a solid content, wherein the amount of the whey protein per 100 parts by mass of the casein protein (ratio solid content by mass) is 50 to 125 parts by mass (“step (a)” or “fermentation step” below); and
(b) a step of heating the obtained fermented milk while it is in the container so that the heat history is at least the following: 75 °C for 15 minutes (“step (b)” or “heating step” below).

The production steps of the present invention described above may include, before step (a), (1) a step of preparing a starting-material milk mix (starting-material milk mix preparation step), (2) a step of homogenizing the starting-material milk mix (homogenization step), and (3) a step of pasteurizing the starting material milk mix (pre-pasteurization Step). These are referred to as “pretreatment steps.” Of these pretreatment steps, homogenization step (2) and pre-pasteurization step (3) can be performed in any order. The starting-material milk mix prepared in step (1) may be subjected to homogenization step (2) and then pre-pasteurization step (3), or may be subjected to pre-pasteurization step (3) and then homogenization step (2), Homogenization step (2) and pre-pasteurization step (3) may also be performed simultaneously.

The production steps of the present invention described above may further include a step (4) of packing the starting-material milk mix obtained in pretreatment steps (1) to (3) in a container (packing step). The packing step may be performed before lactic acid bacteria are added to the starting-material milk mix obtained in pretreatment steps (1) to (3), or may be performed after lactic acid bacteria are added to the starting-material milk mix obtained in pretreatment steps (1) to (3).

Although not limited, the production steps of the present invention preferably include the packing step after pretreatment steps (1) to (3) and before the addition of lactic acid bacteria in step (a). In other words, it is preferable to pack the starting-material milk mix obtained in pretreatment steps (1) to (3) in a container and then subject it to step A, in which lactic acid bacteria are added to the starting-material milk mix packed in the container to allow the mix to ferment in the container.

Each step is described below.

### (1) Starting-Material Milk Mix Preparation Step

The “starting-material milk mix” targeted in the present invention is of a composition containing milk components derived from cow milk and refers to a composition containing whey protein in an amount of 1.5 to 3.0 mass % calculated as a solid content and casein protein in an amount of 2.0 to 3.0 mass % calculated as a solid content, wherein the whey protein is present in an amount of 50 to 125 parts by mass per 100 parts by mass of the casein protein.

The starting-material milk mix is prepared using two or more raw materials selected from raw milk squeezed from cows, cow milk, skim milk, whole milk powder, skim milk powder, whole-milk concentrated milk, skim concentrated milk, sweetened condensed milk, sweetened condensed skim milk, unsweetened condensed milk, unsweetened condensed skim milk, whey, whey powder, desalted whey, desalted whey powder, whey protein concentrate (WPC), whey protein isolate (WPI), α-lactalbumin, β-lactoglobulin, milk protein concentrate (MPC), casein, sodium caseinate, calcium caseinate, cream, fermented cream, compound cream, cream powder, butter, fermented butter, buttermilk, buttermilk powder, butter oil etc. by adjusting the amount of the whey protein and the casein protein so as to achieve the ratio described above in the starting-material milk mix taken as 100 mass %.

It is sufficient if the amount of the whey protein and the casein protein in the starting-material milk mix falls within the ranges above. Although the amount is not limited, the amount of the whey protein is preferably 1.5 to 3.0 mass %, and more preferably 1.7 to 2.5 mass %, and the amount of the casein protein is preferably 2.3 to 3 mass %, and more preferably 2.5 to 3.0 mass %. Furthermore, the amount of the whey protein per 100 parts by mass of the casein protein (the ratio of solid content by mass) is, although not limited thereto, preferably 50 to 120 parts by mass, and more preferably 62 to 100 parts by mass.

Additionally, when cow milk is used as a raw material, it is sufficient if the cow milk has been subjected to the pasteurization stipulated in the Ministerial Ordinance on Milk and Milk Products, which states that milk should be pasteurized at 63 °C for 30 minutes using a holding method or using a method with an equivalent or greater antimicrobial effect. Pasteurization methods include low-temperature long-time pasteurization (LILI) in a holding mode, low-temperature long-time pasteurization (LTLT) in a continuous mode, high-temperature long-time pasteurization (HTLT) in a holding mode, high-temperature short-time pasteurization (HTST), ultra-high-temperature pasteurization (UHT), and long-life pasteurization (LL). Of the milk sold in Japan, 90% is processed with UHT.

The starting-material milk mix can be adjusted so that the content of non-fat milk solids is 8 mass % or more based on the standard for fermented milk. The content of non-fat milk solids is preferably 9 to 12 mass %, and more preferably 9.5 to 11.2 mass %. Although there is no limitation, the starting-material milk mix can be adjusted so that the starting-material milk mix contains milk fat in an amount of 0.5 to 4 mass %, preferably 1 to 3.5 mass %, and more preferably 1.5 to 3.0 mass %, lactose in an amount of 4.4 to 6.7 mass %, preferably 5.0 to 6.2 mass %, and more preferably 5.3 to 5.9 mass %, and saccharides (carbohydrates) other than lactose in an amount of 0 to 10 mass %, preferably 2.5 to 7.5 mass %, and more preferably 4 to 6 mass %.

The starting-material milk mix can be prepared using only the milk components described above, but may also be prepared by adding, in addition to the milk components above, for example, lipids, proteins other than whey protein and casein protein, saccharides, minerals (salts), vitamins, flavor components, fragrances, colorants, and other food additives to the extent that the effects of the present invention are not impaired. Although this is not a strict limitation, it is preferable that the starting-material milk mix targeted by the present invention does not contain any components that fall under the category of gelling agents, thickening polysaccharides, or stabilizers (e.g., the β-glucan-containing material described in PTL 1, and the crosslinked modified starch described in PTL 2).

The starting-material milk mix of the present invention is a composition containing water as well as the milk components. The proportion of water in the starting-material milk mix may be within the range of 11 to 25 mass %, preferably 12 to 20 mass %, and more preferably 13 to 16 mass %.

### (2) Homogenization Step

The step of homogenizing the starting-material milk mix refers to finely grinding (refining) particles composed of proteins and/or fat contained in the starting-material milk mix. The homogenization method can follow standard methods; examples of methods for use include, but are not limited to, stirring a starting-material milk mix while applying shear by using equipment such as a mixer or a pump, passing a starting-material milk mix through a narrow gap while pushing the mix by applying pressure, or passing a starting-material milk mix through a narrow gap while sucking the mix by reducing pressure. The method and equipment for homogenizing starting-material milk are not limited to these methods, and any known method and equipment can be used. The homogenization step may be performed such that the average particle size of the raw milk is 0.8 μm or less.

### (3) Pre-Pasteurization Step

The step of pasteurizing the starting-material milk mix is performed in order to pasteurize the starting-material milk mix until the number of bacteria (excluding spores) contained in the starting-material milk mix becomes 10³ or less per milliliter. Any method and conditions that can achieve this purpose may be used, such as a heat treatment method used for pasteurizing milk. Examples of heat treatment methods used for pasteurizing milk include ultra-high-temperature pasteurization (UHT pasteurization) in which heat treatment is performed at 120 to 150 °C for 2 to 3 seconds, high-temperature short-time pasteurization (HTST pasteurization) in which heat treatment is performed continuously at 72 to 75 °C for 15 seconds or more, high-temperature long-time pasteurization (HILT pasteurization) in which heat treatment is performed at 75 °C or higher for 15 minutes or more in a holding mode, high-temperature short-time pasteurization (HTST pasteurization) in which heat treatment is performed continuously at 72 °C or higher for 15 seconds or more, low-temperature long-time pasteurization (LTLT pasteurization) in which heat treatment is performed at 63 to 65 °C for 30 minutes in a holding mode, low-temperature long-time pasteurization in a continuous mode (LTLT pasteurization) in which heat treatment is performed continuously at 65 to 68 °C for 30 minutes or more, and long-life pasteurization (LL pasteurization) in which heat treatment is performed at 135 to 150 °C for 1 to 4 seconds.

The method is not limited to those described above, and any method can be used as long as the heat history represented by heating temperature (product temperature)×heating time×pressure is equal to or greater than that of the heat treatment methods described above. For example, a method used in the Experimental Examples described below can also be used in which the starting-material milk mix is heated for 1 minute under normal pressure with a product temperature of 95 °C.

### (4) Packing Step

As described above, the step of packing the starting-material milk mix in a container may be performed before the starting-material milk mix is fermented. For example, the step of packing the starting-material milk mix in a container may be performed after the homogenization step and pre-pasteurization step, and before or after adding starter lactic acid bacteria to the starting-material milk mix. The container in which the starting-material milk mix is packed may be any container commonly used in the production of fermented milk (dairy products) by post-fermentation, and there are no particular limitations on the size (volume), material, or shape. For example, the container may be of the size (volume) for one person for a single serving, or for family or commercial use. The container for use may be made of any material, such as plastic, glass, paper, or other materials. The container may be of any shape as long as it has strength and sealing properties; for example, the container may be of a cup shape, a brick pack shape, or a cheer pack shape. The method and equipment for filling the container may be a commonly used method and equipment.

### (a) Fermentation Step

In the present invention, the fermentation step can be performed by adding starter lactic acid bacteria to a starting-material milk mix and then fermenting the starting-material milk mix in a container. The lactic acid bacteria used as a starter may be one or a combination of two or more selected from lactic acid bacteria commonly used in the production of fermented milk, Such as Lactobacillus bulgaricus (L. bulgaricus), Streptococcus thermophilus (S. thermophilus), Lactobacillus lactis (L. lactis), Lactobacillus gasseri (L. gasseri), Lactobacillus plantarum (L. plantarum), Lactobacillus casei (L. casei), Lactobacillus acidophilus (L. acidophilus), and Bifidobacterium. Preferably, the lactic acid bacteria is Lactobacillus bulgaricus. Additionally, from the perspective of being standardized as a yogurt starter in the Codex Alimentarius, a mixed starter of Lactobacillus bulgaricus and Streptococcus thermophilus is also usable.

The amount of the starter (lactic acid bacteria) added to the starting-material milk mix may be any amount commonly used in the production of fermented milk, and is, for example, 0.1 to 10 mass %, preferably 0.2 to 5 mass %, and more preferably 0.5 to 4 mass % relative to the starting-material milk mix. The starter may be added according to any method commonly used in the production of fermented milk, such as a method of aseptically adding the starter to a starting-material milk mix packed in a container, or a method of adding the starter in-line with the starting-material milk mix flowing through a pipe and then filling a container with the mixture. The method and equipment for adding the starter to the starting-material milk mix are not limited to those described above, and any known method and equipment can be used.

Fermentation of the starting-material milk mix can be performed by adding a starter (lactic acid bacteria) and then allowing the mix packed in a container to stand in a fermentation room set at a predetermined temperature. The conditions for fermenting the starting-material milk mix are adjusted taking into consideration the type and amount of lactic acid bacteria, etc. added to the starting-material milk, as well as the flavor, texture, physical properties, etc. of the fermented milk to be obtained.

For example, the lower limit of the temperature at. which the starting-material milk mix is fermented (fermentation temperature) is preferably 33 °C or higher, more preferably 35 °C or higher, and even more preferably 38 °C or higher. The upper limit of the temperature at which the starting-material milk is fermented is preferably 50 °C or lower, more preferably 48 °C of lower, and even more preferably 45 °C or lower. The fermentation temperature range can be set by appropriately combining these lower and upper limits. Although not limited thereto, the fermentation temperature range may be, for example, 33 to 50 °C, 35 to 48 °C, or 38 to 45 °C.

The time for fermenting starting-material milk (fermentation time) is the period until the pH of fermented milk falls within the range of 5.3 to 5.9. In other words, fermentation is ended when the pH of the fermented milk reaches a point within the range of 5.3 to 5.9. The pH range within which fermentation is ended is preferably 5.4 to 5.8, and more preferably 5.5 to 5.7. Ending fermentation within this pH range results in fermented milk that is less acidic, which is one of the effects of the invention, with a tofu-like texture (firmness, mouthfeel). The method and equipment used for fermenting the starting-material milk mix can be any known method and equipment.

### (b) Heating Step

The heating step is a step of heating the fermented milk that has reached a predetermined pH in the fermentation step, with the fermented milk packed in a container. The heat treatment is performed without stirring the fermented milk (under non-stirring conditions). This step is performed to kill the lactic acid bacteria added as a starter to the starting-material milk mix to prevent the progress of fermentation, and to kill bacteria to ensure the hygienic safety and expiration date of the food.

The heat treatment may be performed according to any method under any conditions that can achieve this purpose. For example, a heat treatment method with the heat history represented by heating temperature (product temperature)×heating time×pressure being equal to or greater than 75 °C×15 minutes×normal pressure can be used. The heat history of 75 °C×15 minutes×normal pressure means that after the product temperature reaches 75 °C under normal pressure, the product is heated for 15 minutes under the same temperature conditions. In this manner, it is possible to obtain pasteurized fermented milk that meets the standards for pasteurized fermented milk set forth in the Ministerial Ordinance on Milk and Milk Products (fermented milk that is produced by performing pasteurization by heating at 75 °C for 15 minutes or more after fermentation, or pasteurization using a method that has an equivalent or greater antimicrobial effect). An example of the heating method that achieves a heat history of at least 75 °C×15 minutes×normal pressure is a heat treatment in which a product is immersed in hot water at 85 °C for 60 minutes under normal pressure. Note that the normal pressure as used herein means that the pressure inside a container is normal pressure and does not include a pressure that has been artificially increased or decreased. The heat treatment may be performed after fermented milk packed in a container is packaged and sealed. Alternatively, fermented milk packed in a container may be heated before being sealed and packaged, and then sealed and packaged. Any known method and equipment can be used for heating fermented milk together with its container.

After being cooled, the pasteurized fermented milk thus produced can be directly distributed in the market in its state of being packed, sealed, and packaged in containers. As described in the Examples below, the pasteurized fermented milk obtained according to the production method of the present invention has shape retention and/or resistance to disintegration when boiled, and is less sour with a tofu-like firmness and texture (silken tofu and firm tofu). Thus, the pasteurized fermented milk can be used in a variety of recipes as an ingredient containing milk protein, replacing tofu.

In the present specification, the terms “comprise” and “contain” include the meanings of consisting of and consisting essentially of.

### EXAMPLES

The present invention is described with reference to Experimental Examples in order to help to understand the elements and effects of the invention. However, the present invention is not limited in any way by these Experimental Examples. Unless otherwise specified, the following experiments were performed at room temperature (25±5 °C) under atmospheric pressure (normal pressure). Unless otherwise specified, the unit “%” below means mass %, and the unit “parts” below means parts by mass.

The raw materials used in the following Experimental Examples (Examples and Comparative Examples) are as follows.
Milk: whole milk (milk protein: 3.0 to 3.6%, milk fat: 3.5 to 4.2%, non-fat milk solids: 8.5 to 9.3%) (produced by Meiji Co., Ltd.)
Milk protein concentrate (MPC); MPC80 (casein: 64.4%, whey: 16.1%) Lacto Japan Co., Ltd.
Whey protein isolate (WPI): WPI895 (whey: 93.5%) Fonterra Japan Lactic acid bacteria starter: Lactobacillus bulgaricus OLL1073R-1 (1073R-1 lactic acid bacteria) isolated from Meiji Probio Yogurt R-1 (produced by Meiji Co., Ltd.)

### Experimental Example 1; Effects of Type and Content of Milk Protein, Whether Secondary Heat Treatment is Performed, and pH at the End of Fermentation

Various types of fermented milk (Examples 1 and 2, Comparative Examples 1 to 10) were prepared according to the method described below, and evaluation was made on how the type and content of milk protein added to a starting-material milk mix, whether secondary heat treatment is performed, and pH at the end of fermentation affect the shape retention, resistance to disintegration when boiled, and texture of the obtained fermented milk.

### (1) Preparation of Fermented Milk

### (a) Secondary Heat Treatment Was Not Performed After Fermentation

### Comparative Examples 1 to 6

MPC or WPI in an amount of 2% was added to 500 g of cow milk (homogenized during the production step) and mixed to prepare starting-material milk containing the components shown in Table 1 (Comparative Examples 1 to 3: MPC added, Comparative Examples 4 to 6: WPI added), The starting-material milk was heated at 95 °C for 1 minute (pre-pasteurization) to prepare a starting-material milk mix. The starting-material milk mix was cooled to 43 °C, and a lactic acid bacteria starter was added (inoculated) in an amount of 3%. Thereafter, the mixture was packed into a cylindrical plastic cup container (diameter: 7 cm, volume capacity: 100 g) and left to stand in a fermentation room (43 °C) for fermentation until the pH shown in Table 1 was reached. After the pH reached the predetermined value, the mixture was cooled in a refrigerator (10 °C or lower), thereby producing fermented milk (Comparative Examples 1 to 6).

### (b) Secondary Heat Treatment Was Performed After Fermentation

### Comparative Examples 7 to 10 and Examples 1 and 2

MPC (or WPI) in an amount of 2% was added to 500 g of cow milk (homogenized during the production step) and mixed to prepare starting-material milk containing the components shown in Table 1 (Comparative Examples 7 to 10: MPC added, Comparative Example 11 and Examples 1 and 2: WPI added). This starting-material milk was heated at 95 °C for 1 minute (pre-pasteurization) to prepare a starting-material milk mix. The starting-material milk mix was cooled to 43 °C, and a lactic acid bacteria starter was added (inoculated) in an amount of 3%.

Thereafter, the mixture was packed into a plastic cup container (volume capacity: 100 g) and left to stand in a fermentation room (43 °C) for fermentation until the pH shown in Table 1 was reached. After the pH reached a predetermined value, the container was immersed in hot water at 85 °C for 60 minutes (secondary heat treatment) and then transferred and immersed in ice-cold water for 30 minutes to cool, thereby producing pasteurized fermented milk (Comparative Examples 7 to 10 and Examples 1 and 2).

TABLE 1

| | | | | | | Fermentated Milk Production Method | | | | | |
|---|---|---|---|---|---|---|---|---|---|---|---|
| | Components of Starting-material Milk | | | | | No Secondary Heat Treatment | | | With Secondary Heat Treatment | | |
| | | | Amount | | | pH at the | pH at the | pH at the | pH at the | pH at the | pH at the |
| Amount of | Milk Protein | | of Whey | | | End of | End of | End of | End of | End of | End of |
| MPC/WPI | (%) | | Per 100 | [symbol] | Fat | Fermentation | Fermentation | Fermentation | Fermentation | Fermentation | Fermentation |
| (%) | Whey | Casein | of Casein | (%) | (%) | [symbol] | 5.4 | 5.0 | 5.8 | 5.4 | 5.0 |
| MPC 2% | 0.94 | 3.76 | 25.0 | 10.53 | 3.82 | Comparative | Comparative | Comparative | Comparative | Comparative | Comparative |
| | | | | | | Example [symbol] | Example 2 | Example 3 | Example 7 | Example [symbol] | Example 9 |
| WPI 2% | 2.49 | 2.48 | 100.4 | 10.57 | 3.59 | Comparative | Comparative | Comparative | Example 1 | Example 2 | Comparative |
| | | | | | | Example 4 | Example [symbol] | Example 6 | | | Example 10 |

[symbol]

indicates data missing or illegible when filed

### (2) Evaluation of Prepared Pasteurized Fermented Milk

### (a) Physical State and Shape Retention

As described above, after preparation, the containers were turned upside down to place the cooled fermented milk (Comparative Examples 1 to 6) and pasteurized fermented milk (Comparative Examples 7 to 10 and Examples 1 and 2) (product temperature 25 °C) directly on a plate, and their physical state (liquid, semi-solid, or firm) was confirmed. If fermented milk left to stand for 60 minutes was in a fluid state like cow milk, the fermented milk was determined to be “in a liquid form.” If fermented milk was in a semi-fluid state like a shake or soft yogurt and breaks apart under its own weight, failing to maintain its shape, the fermented milk was determined to be “in a semi-liquid state.” In both cases, the fermented milk was evaluated as “shape retention: ×.” Fermented milk that was able to maintain its shape without breaking under its own weight was determined to be “firm” and evaluated as “shape retention: ○.” Not only the case in which the cup shape was maintained but also the case in which the cup shape had sagged slightly due to its own weight with the corners (edges) not broken was also evaluated as maintaining the shape without breaking.

### (b) Resistance to Disintegration When Boiled

After preparation, among the cooled fermented milk (Comparative Examples 1 to 10 and Examples 1 and 2), fermented milk that was determined to be firm was evaluated for resistance to disintegration when boiled. Resistance to disintegration when boiled was evaluated by immersing 100 g of pasteurized fermented milk directly from the container in 1 L of hot water (80 °C) for 10 minutes and comparing the shape before and after immersion. Fermented milk with the shape broken overall was determined to be “resistance to disintegration when boiled: ×”, fermented milk with only part of the shape broken was determined to be “resistance to disintegration when boiled: Δ”, and fermented milk with the shape not broken was determined to be “resistance to disintegration when boiled: ○”. Not only the case in which the shape before immersion was maintained, but also the case in which the shape was swollen overall after immersion in hot water with the corners (edges) not broken was evaluated as maintaining the shape.

### (c) Sourness and Texture

A panel of six experts trained in sensory evaluation tasted fermented milk samples that had been cooled to 10 °C after prepared (Comparative Examples 1 to 10 and Examples 1 and 2), and evaluated the sourness and texture (firmness and mouthfeel) according to the following methods,

### Sourness

The sourness of each fermented milk sample (Comparative Examples 1 to 10 and Examples 1 and 2) was evaluated according to the following criteria in comparison with commercially available sour plain yogurt (product name: Meiji Bulgaria Yogurt LB81 Plain, produced by Meiji Co., Ltd., pH of 4.2, control).
“Sour: +”: Sour to the same extent as the control.
“Slightly sour: ±”: Less sour than the control, but still slightly sour
“No sourness: −”: No sourness is felt.

### Texture

The fermented milk samples (Comparative Examples 1 to 10 and Examples 1 and 2) were classified according to the texture (firmness and texture felt on the tongue (sensation when fermented milk is placed in the mouth and squished with the tongue)) in comparison with the texture of commercially available regular firm tofu and silken tofu (control) and evaluated for quality of the texture according to the following criteria.

TABLE 2

| | | Evaluation |
|---|---|---|
| Classi- | | Quality of |
| fication | Criteria | Texture |
| 5 | Coarser texture than firm tofu | X |
| 4 | Firmer than firm tofu | X |
| 3 | Having firmness and texture equivalent to those of | ◯ |
| | firm tofu | |
| 2 | Having firmness and texture between silken tofu and | ⊚ |
| | firm tofu | |
| 1 | Having firmness and texture equivalent to silken | ◯ |
| | tofu | |
| 0 | Softer than silken tofu | X |

The firm tofu and silken tofu used as controls both met the standards listed in the General Composition Table—Inorganic Substances and Vitamins of the 2020 Edition (8th Revised) of the Standard Tables of Food Composition in Japan (Ministry of Education, Culture, Sports, Science and Technology of Japan). The maximum loads (N) of firm tofu and silken tofu (three specimens each) measured in the breaking test described below were as shown in Table 3.

TABLE 3

| | Specimen 1 | Specimen 2 | Specimen 3 | Average |
|---|---|---|---|---|
| Firm Tofu | 6.93 | 7.15 | 7.86 | 7.31N |
| Silken Tofu | 5.07 | 5.38 | 5.79 | 5.41N |

### Breaking Test

### (1) Measuring Equipment

Creep meter (viscoelasticity analyzer): Rheoner II (model number: RE-33058, parallel plate) produced by Yamaden Co., Ltd.

### (2) Breaking Test Conditions

Plunger: Disc-shaped (diameter: 3 cm, thickness: 8 mm)
Contact area with test sample: 7.1 cm
Compression speed: 1 mm/sec
Compression distance: 10 mm

### (3) Breaking Test Method

A test sample (product temperature: 25 °C) in a plastic cup container (volume capacity: 100 g) was placed on the test stand of the creep meter. A plunger was lowered from above the test sample and brought into contact with the surface of the test sample to apply a load in the thickness direction, thereby performing a breaking test under the above conditions. The compression curve was recorded and analyzed using an automatic analyzer (model number: CA-3305, produced by Yamaden Co., Ltd.), a peak indicator (model number: PA-3305, produced by Yamaden Co., Ltd.), and a recorder. The maximum value of the load (N) applied during the period from the start of measurement until the test sample broke was recorded as the maximum load (N).

### (3) Evaluation Results

Table 4 shows the evaluation results of the fermented milk produced in section (1) (Comparative Examples 1 to 10 and Examples 1 and 2).

TABLE 4

| Components of Starting-material | | | | | Fermented Milk Production Method | | | | | |
|---|---|---|---|---|---|---|---|---|---|---|
| Milk Mix (100%) | | | | | No Secondary Heat Treatment | | | With Secondary Heat Treatment | | |
| | | | Amount | | pH at the | pH at the | pH at the | pH at the | pH at the | pH at the |
| Amount of | Milk Protein | | of Whey | | End of | End of | End of | End of | End of | End of |
| MPC/WPI | (%) | | Per 100 | | Fermentation | Fermentation | Fermentation | Fermentation | Fermentation | Fermentation |
| (%) | Whey | Casein | of Casein | Evaluation Item | 5.8 | 5.4 | 5.0 | 5.8 | 5.4 | 5.0 |
| MPC 2% | | | | | Comparative | Comparative | Comparative | Comparative | Comparative | Comparative |
| WPI 0% | 0.94 | 3.78 | 26.0 | | Example 1 | Example 2 | Example 3 | Example 7 | Example [symbol] | Example [symbol] |
| | | | | Physical State | Liquid | Liquid | Semi-solid | Semi-solid | Firm | Firm |
| | | | | Shape Retention | X | X | X | X | ◯ | ◯ |
| | | | | Resistance to | NO | NO | NO | NO | [symbol] | [symbol] |
| | | | | Disintegration | | | | | | |
| | | | | When Boiled | | | | | | |
| | | | | [symbol] | − | − | + | − | − | + |
| | | | | Texture | [symbol] | [symbol] | [symbol] | [symbol] | [symbol] | [symbol] |
| | | | | (Classification: | | | | | | |
| | | | | Evaluation) | | | | | | |
| MPC 2% | | | | | Comparative | Comparative | Comparative | | | Comparative |
| WPI 0% | 2.48 | 2.48 | 100.4 | | Example 4 | Example 5 | Example 6 | Example 1 | Example 2 | Example 10 |
| | | | | Physical State | Firm | Firm | Firm | Firm | Firm | Firm |
| | | | | Shape Retention | ◯ | ◯ | ◯ | ◯ | ◯ | ◯ |
| | | | | Resistance to | Δ | Δ | Δ | ◯ | ◯ | ◯ |
| | | | | Disintegration | | | | | | |
| | | | | When Boiled | | | | | | |
| | | | | [symbol] | − | − | + | − | − | + |
| | | | | Texture | [symbol] | [symbol] | [symbol] | [symbol] | [symbol] | [symbol] |
| | | | | (Classification: | | | | | | |
| | | | | Evaluation) | | | | | | |

[symbol]

ND: Not Meseured [symbol]
indicates data missing or illegible when filed

As shown in Table 4, a starting-material milk mix (as a fermented milk material) for use was prepared by adding WPI to cow milk so as to contain milk protein in the following manner. whey in an amount of 2.49 mass % and casein in an amount of 2.48 mass % (the amount of whey per 100 parts by mass of casein: 100.4 parts by mass). The starting-material milk mix was fermented in individual containers with lactic acid bacteria until the pH reached 5.4 to 5.8, and then the containers were subjected to secondary heat treatment (heat history equivalent to at least 75 °C×15 minutes×normal pressure) in that pH range. This resulted in set-type pasteurized fermented milk (Examples 1 and 2) that had good shape retention and did not easily disintegrate even when boiled. Additionally, the set-type pasteurized fermented milk did not have the sour taste felt in regular yogurt and was firmer than silken tofu but softer than firm tofu, with a good texture.

Fermented milk (Comparative Examples 1 to 3 and 7 to 9) was prepared using a starting-material milk mix (as a fermented milk material) that was prepared by adding MPC to cow milk so as to contain milk protein in the following manner: whey in an amount of 0.94 mass % and casein in an amount of 3.76 mass % (the amount of whey per 100 parts by mass of casein: 25.0 parts by mass). The fermented milk (Comparative Examples 1 to 3 and 7 to 9) had poor shape retention, or had good shape retention but poor resistance to disintegration when boiled. Furthermore, fermented milk prepared by adding WPI to cow milk as a fermented milk material so that the milk protein content was the same as in Examples 1 and 2 (Comparative Examples 4 to 6 and 10) had good shape retention, but the fermented milk that was not subjected to secondary heat treatment (Comparative Examples 4 to 6) did not have good resistance to disintegration when boiled. Even when secondary heat treatment was performed, fermented milk for which the pH at the end of fermentation was set to 5 or less (Comparative Example 10) had good shape retention and resistance to disintegration when boiled, but tended to have a strong sour taste and an overly firm texture.

### Experimental Example 2: Effect of WPI Content

### (1) Production of Fermented Milk

Based on the results of Experimental Example 1, various fermented milk samples (Examples 3 to 8 and Comparative Examples 11 to 26) were prepared using WPI as a milk protein concentrate in the amount shown in Table 5 (see Table 5). The fermented milk of Comparative Examples 11 to 21 was prepared according to the method described in Experimental Example 1 (1) (a) above (pH at the end of fermentation: 5.8 or 5.4, no secondary heat treatment), and the fermented milk of Examples 3 to 8 and Comparative Examples 22 to 26 was prepared according to the method described in Experimental Example 1 (1) (b) above (pH at the end of fermentation: 5.8 or 5.4: with secondary heat treatment).

TABLE 5

| | | | | | | Fermented Milk Production Method | | | |
|---|---|---|---|---|---|---|---|---|---|
| | Components of Starting-material Milk | | | | | No Secondary Heat Treatment | | With Secondary Heat Treatment | |
| | | | Amount | | | pH at the | pH at the | pH at the | pH at the |
| Amount | Milk Protein | | of Whey | Non-fat | | End of | End of | End of | End of |
| of WPI | (%) | | Per 100 | Solids | Fat | Fermentation | Fermentation | Fermentation | Fermentation |
| (%) | Whey | Casein | of Casein | (%) | (%) | 5.8 | 5.4 | 5.8 | 5.4 |
| 0.0 | 0.63 | 2.53 | 24.9 | 8.83 | 3.68 | Comparative | Comparative | Comparative | Comparative |
| | | | | | | Example 11 | Example 12 | Example 22 | Example 23 |
| 0.5 | 1.30 | 2.51 | 43.8 | 9.27 | 3.54 | Comparative | Comparative | Comparative | Comparative |
| | | | | | | Example 13 | Example 14 | Example 24 | Example [symbol] |
| 1.0 | 1.66 | 2.50 | 62.4 | 9.70 | [symbol] | Comparative | Comparative | Example 3 | Example 4 |
| | | | | | | Example 15 | Example 16 | | |
| 1.5 | 2.02 | 2.49 | 81.1 | 10.14 | 3.61 | Comparative | Comparative | Example 5 | Example 6 |
| | | | | | | Example 17 | Example 18 | | |
| 2.6 | 2.95 | 2.46 | 110.9 | 11.01 | 3.67 | Comparative | Comparative | Example 7 | Example 8 |
| | | | | | | Example 19 | Example 20 | | Comparative |
| 3.0 | 3.42 | 2.45 | 139.6 | 11.44 | 3.65 | | Comparative | | Example 26 |
| | | | | | | | Example 21 | | |

[symbol]

indicates data missing or illegible when filed

### (2) Evaluation of Fermented Milk

The obtained fermented milk was evaluated in terms of physical state, shape retention, resistance to disintegration when boiled, sourness, and texture (firmness and mouthfeel) in the same manner as in Experimental Example 1. For firm fermented milk, a breaking test was performed in accordance with the breaking test method performed for tofu in Experimental Example 1, and the maximum load (N) was determined. The fermented milk determined to be firm was subjected to the test for resistance to disintegration when boiled, and the turbidity of the broth after the test was further measured according to the method described below. From the turbidity, the degree of disintegration of the fermented milk (degree of leakage of contents, such as milk fat and milk protein) was evaluated.

### Turbidity Test

Fermented milk (100 g) removed from the container is immersed in 1 L of hot water (80 °C) for 10 minutes to evaluate resistance to disintegration when boiled. Thereafter, the residual liquid after fermented milk is removed is used as broth. After being cooled, the broth is passed through a 60 #filter, and the turbidity (NTU) of the filtrate is measured with a 200P Turbidimeter (HACH). According to the turbidity (NTU) of the filtrate, evaluation was made as follows:
○: <5 NTU
Δ: 10 to 5 NTU
×: >10 NTU

### (3) Evaluation Results

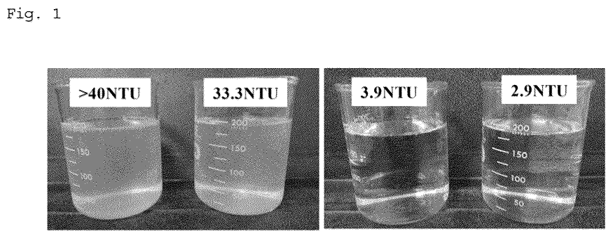

Table 6 shows the evaluation results of the fermented milk produced in section (1) (Comparative Examples 11 to 26 and Examples 3 to 8). FIG. 1 shows images of the broth (contained in a beaker) of Comparative Examples 24 and 25 and Examples 5 and 6 that was subjected to the broth turbidity test.

TABLE 6

| | | | | | Fermented Milk Production Method | | | |
|---|---|---|---|---|---|---|---|---|
| Components of Starting-material Milk [symbol] | | | | | No Secondary | | With Secondary | |
| (100%) | | | | | Heat Treatment | | Heat Treatment | |
| | | | Amount | | pH at the | pH at the | pH at the | pH at the |
| Amount | Milk Protein | | of Whey | | End of | End of | End of | End of |
| of WPI | (%) | | Per 100 | Evaluation | Fermentation | Fermentation | Fermentation | Fermentation |
| (%) | Whey | Casein | of Casein | Item | 5.8 | 5.4 | 5.8 | 5.4 |
| | | | | | Comparative | Comparative | Comparative | Comparative |
| 0% | [symbol] | [symbol] | [symbol] | | Example 11 | Example 12 | Example [symbol] | Example [symbol] |
| | | | | Physical State | Liquid | Semi-solid | Firm | Firm |
| | | | | Shape Retention | [symbol] | [symbol] | ◯ | ◯ |
| | | | | [symbol] | NO | NO | NO | NO |
| | | | | [symbol] | NO | NO | [symbol] | [symbol] |
| | | | | [symbol] | [symbol] | [symbol] | [symbol] | [symbol] |
| | | | | [symbol] | [symbol] | [symbol] | [symbol] | [symbol] |
| | | | | Evaluation | [symbol] | [symbol] | [symbol] | [symbol] |
| | | | | [symbol] | [symbol] | [symbol] | [symbol] | [symbol] |
| | | | | Texture | [symbol] | [symbol] | [symbol] | [symbol] |
| | | | | (Classification: | | | | |
| | | | | Evaluation) | | | | |
| | | | | | Comparative | Comparative | Comparative | Comparative |
| [symbol] | [symbol] | [symbol] | [symbol] | | Example 12 | Example [symbol] | Example 24 | Example [symbol] |
| | | | | Physical State | Liquid | Semi-solid | [symbol] | Semi-solid |
| | | | | Shape Retention | [symbol] | [symbol] | ◯ | [symbol] |
| | | | | [symbol] | NO | NO | NO | NO |
| | | | | [symbol] | NO | NO | Δ | NO |
| | | | | [symbol] | [symbol] | [symbol] | [symbol] | [symbol] |
| | | | | [symbol] | [symbol] | [symbol] | [symbol] | [symbol] |
| | | | | Evaluation | [symbol] | [symbol] | [symbol] | [symbol] |
| | | | | [symbol] | [symbol] | [symbol] | [symbol] | [symbol] |
| | | | | Texture | [symbol] | [symbol] | [symbol] | [symbol] |
| | | | | (Classification: | | | | |
| | | | | Evaluation) | | | | |
| | | | | | Comparative | Comparative | | |
| [symbol] | [symbol] | [symbol] | [symbol] | | Example 15 | Example 18 | Example 3 | Example 4 |
| | | | | Physical State | | | | |
| | | | | Shape Retention | ◯ | ◯ | ◯ | ◯ |
| | | | | [symbol] | NO | [symbol] | [symbol] | [symbol] |
| | | | | [symbol] | Δ | Δ | ◯ | ◯ |
| | | | | [symbol] | [symbol] | [symbol] | [symbol] | [symbol] |
| | | | | [symbol] | [symbol] | [symbol] | [symbol] | [symbol] |
| | | | | Evaluation | [symbol] | [symbol] | [symbol] | [symbol] |
| | | | | [symbol] | [symbol] | [symbol] | [symbol] | [symbol] |
| | | | | Texture | [symbol] | [symbol] | [symbol] | [symbol] |
| | | | | (Classification: | | | | |
| | | | | Evaluation) | | | | |
| | | | | | Comparative | Comparative | | |
| [symbol] | [symbol] | [symbol] | [symbol] | | Example 17 | Example 18 | Example 5 | Example 6 |
| | | | | Physical State | [symbol] | [symbol] | [symbol] | [symbol] |
| | | | | Shape Retention | ◯ | ◯ | ◯ | ◯ |
| | | | | [symbol] | NO | NO | NO | NO |
| | | | | [symbol] | Δ | Δ | ◯ | ◯ |
| | | | | [symbol] | [symbol] | [symbol] | [symbol] | [symbol] |
| | | | | [symbol] | [symbol] | [symbol] | [symbol] | [symbol] |
| | | | | Evaluation | [symbol] | [symbol] | [symbol] | [symbol] |
| | | | | [symbol] | [symbol] | [symbol] | [symbol] | [symbol] |
| | | | | Texture | [symbol] | [symbol] | [symbol] | [symbol] |
| | | | | (Classification: | | | | |
| | | | | Evaluation) | | | | |
| | | | | | Comparative | Comparative | | |
| [symbol] | [symbol] | [symbol] | [symbol] | | Example 19 | Example 20 | Example 7 | Example 8 |
| | | | | Physical State | Firm | Firm | [symbol] | Firm |
| | | | | Shape Retention | ◯ | ◯ | ◯ | ◯ |
| | | | | [symbol] | NO | NO | [symbol] | [symbol] |
| | | | | [symbol] | Δ | Δ | ◯ | ◯ |
| | | | | [symbol] | [symbol] | [symbol] | [symbol] | [symbol] |
| | | | | [symbol] | [symbol] | [symbol] | [symbol] | [symbol] |
| | | | | Evaluation | [symbol] | [symbol] | [symbol] | [symbol] |
| | | | | [symbol] | [symbol] | [symbol] | [symbol] | [symbol] |
| | | | | Texture | [symbol] | [symbol] | [symbol] | [symbol] |
| | | | | (Classification: | | | | |
| | | | | Evaluation) | | | | |
| [symbol] | [symbol] | [symbol] | [symbol] | | | Comparative | | Comparative |
| | | | | | | Example [symbol] | | Example [symbol] |
| | | | | Physical State | | Firm | | Firm |
| | | | | Shape Retention | | ◯ | | ◯ |
| | | | | [symbol] | | NO | | NO |
| | | | | [symbol] | | ◯ | | [symbol] |
| | | | | [symbol] | | [symbol] | | [symbol] |
| | | | | [symbol] | | [symbol] | | [symbol] |
| | | | | Evaluation | | [symbol] | | [symbol] |
| | | | | [symbol] | | [symbol] | | [symbol] |
| | | | | Texture | | [symbol] | | [symbol] |
| | | | | (Classification: | | | | |
| | | | | Evaluation) | | | | |

N [symbol] : Not Measured
Note:

[symbol]

[symbol]

indicates data missing or illegible when filed

As shown in Table 6, a starting-material milk mix was used as a fermented milk material, which was prepared so that the milk protein was 1.56 to 2.95 mass % of whey and 2.46 to 2.5 mass % of casein, with the amount of whey per 100 parts by mass of casein being in the range of 62.4 to 119.9 parts by mass. The starting-material milk mix was fermented in a container with lactic acid bacteria until the pH reached 5.4 to 5.8, and then the container was subjected to secondary heat treatment (heat history equivalent to at least 75 °C×15 minutes'normal pressure) in that pH range. The thus-obtained set-type pasteurized fermented milk (Examples 3 to 8) was confirmed to have good shape retention and does not easily disintegrate even when boiled. The set-type pasteurized fermented milk was also confirmed to not have a sour taste that is felt in regular yogurt and have a texture (firmness and mouthfeel) like tofu (firm tofu to silken tofu).

Also, fermented milk (Comparative Examples 11 to 14 and 22 to 25) was prepared using a starting-material milk mix prepared as a fermented milk material so that the milk protein was 0.63 to 1.1 mass of whey and 2.51 to 2.53 mass % of casein (the amount of whey per 100 parts by mass casein: 24.9 to 43.8 parts by mass). The fermented milk (Comparative Examples 11 to 14 and 22 to 25) either had poor shape retention or had poor resistance to disintegration when boiled even if it had good shape retention. Fermented milk (Comparative Examples 15 to 20) prepared using a fermented milk material prepared so that the milk protein content was the same as in Examples 3 to 8 but without secondary heat treatment had good shape retention but poor resistance to disintegration when boiled, and the broth was also highly turbid. Additionally, fermented milk (Comparative Examples 21 and 26) prepared using a starting-material milk mix as a fermented milk material prepared such that the milk protein content is 3.42 mass % of whey and 2.45 mass % of casein (the amount of whey per 100 parts by mass of casein: 139.6 parts by mass) had good shape retention and resistance to disintegration when boiled, but tended to have an overly firm texture.

### INDUSTRIAL APPLICABILITY

Fermented milk, which is a healthy food, can now be used in applications that have not been seen before (general purpose cooking applications; e.g., tofu-like food ingredients: ingredients for hot pot, tofu steak, chilled tofu, and mapo tofu). The fermented milk of the present invention does not disintegrate when boiled, with no loss of whey protein into the broth, making it possible to consume it. The present invention has enabled obtaining fermented milk that is not sour. Overall, this will lead to the development of healthy eating scenes and the development of new fermented milk markets,

1. A set-type pasteurized fermented milk, comprising
whey protein in an amount of 1.5 to 3.0 mass %, and
casein protein in an amount of 2.0 to 3.0 mass %,
wherein
the amount of the whey protein per 100 parts by mass of the casein protein is 50 to 125 parts by mass, and
the set-type pasteurized fermented milk has a pH of 5.3 to 5.9.

2. The pasteurized fermented milk according to claim 1, comprising non-fat milk solids in an amount of 9.5 to 11.2 mass %.

3. The pasteurized fermented milk according to claim 1, having shape retention and/or resistance to disintegration when boiled.

4. The pasteurized fermented milk according to claim 1, having a maximum load at break of 5.0 to 8.0 N in a breaking test using a plunger.

5. A method for producing a set-type pasteurized fermented milk comprising the steps of:
adding lactic acid bacteria to a starting-material milk mix to ferment the starting-material milk mix in a container until the pH reaches 5.3 to 5.9, wherein the starting-material milk mix contains whey protein in an amount of 1.5 to 3.0 mass % and casein protein in an amount of 2.0 to 3.0 mass %, and the amount of the whey protein per 100 parts by mass of the casein protein is 50 to 125 parts by mass; and
heating the obtained fermented milk together with the container so that the heat history is at least the following: 75 C×15 minutes×normal pressure.

6. The method according to claim 5, wherein the starting-material milk mix contains non-fat milk solids in an amount of 9.5 to 11.2 mass %.

7. The method according to claim 5, wherein the starting-material milk mix is subjected to homogenization and pasteurization before the addition of the lactic acid bacteria.

8. The method according to claim 7, further comprising, before the addition of lactic acid bacteria, the step of subjecting the starting-material milk mix to homogenization and pasteurization, the starting-material milk mix containing the whey protein in an amount of 1.5 to 3.0 mass % and the casein protein in an amount of 2.0 to 3.0 mass %, wherein the amount of the whey protein per 100 parts by mass of the casein protein is 50 to 125 parts by mass.

9. The method according to claim 5, wherein the fermentation temperature is 35 to 48 °C.

10. The method according to claim 7, wherein the fermentation temperature is 35 to 48 °C.
